(19) United States
(12) Patent Application Publication
(10) Pub. No.: US 2007/0120823 A1
(43) Pub. Date: May 31, 2007

(54) Automatic click input system

(76) Inventors: Rieko Otsuka, Fuchu (JP); Youichi Horii, Mitaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/606,007

(22) Filed: Nov. 30, 2006

(30) Foreign Application Priority Data
Nov. 30, 2005 (JP) 2005-344875

(51) Int. Cl. G09G 5/00

(52) U.S. Cl. 345/156

(57) ABSTRACT

Position change of a cursor and an input from a keyboard are monitored and when the cursor is stopping over a predetermined time and also there has not been an input from the keyboard over a predetermined time retroactively from the present time, a click event is made to automatically occur.

### CLAIM OF PRIORITY

The present application claims priority of Japanese application JP 2005-344875 filed on Nov. 30, 2005, the content of which is hereby incorporated by reference into this application.

### BACKGROUND OF THE INVENTION

The present invention relates to a method and a system for automating a click input work in the computer operation.

When operating a personal computer, a mouse, a track ball, and a joystick, etc. are widely used as an input device for the movement of a cursor on a monitor or to select. Generally, in the input device such as a mouse an operation called a click is necessary when selecting, but when the click operation is used so often a large strain is put on the fingers and hand and if a user continues working for a long time the symptom can progress to the tenosynovitis. As a prevention of the tenosynovitis, it is considered that it is desirable to reduce as much as possible the time to use the mouse or the number of times of the click. On the other hand, for a physically handicapped person who has difficulty conducting the click operation itself a technique which supports the input work has been proposed. For example, as described in Japanese Patent Application Publication No. 10-55248, a technique in which a user operates a cursor on a display screen with his or her feet is proposed. Also, in Japanese Patent Application Publication No. 2005-18222 an input method is proposed which detects a movement of the cursor position on a screen and when there has not been a movement within a predetermined time a click event is made to occur.

### SUMMARY OF THE INVENTION

However, with the method of JP-A-10-55248 a dedicated apparatus to operate with feet is necessary and it cannot be used easily wherever, for example, when conducting the PC work at a moving destination. Also, in the method of JP-A-2005-18222 a technique which presents the time until a click event is made to automatically occur by count-down display and sound is proposed, but when working mainly inputting text there is a case in which it is desirable to prevent the click event from occurring automatically by the movement of the cursor. For example, when operating on a keyboard, if the mouse is moved unintentionally a click event occurs at an unexpected position and there is a possibility such as that a caret (a letter input pointer) is flied from the position where the user wants to input. Also, when working on the PC not only a single click but also a double click is sometimes necessary when opening a folder or a file, etc., but the technique of JP-A-2005-18222 is limited to the single click.

An object of the present invention is to provide a method and a system which are aimed to solve the above-mentioned problems of the prior art.

Another object of the present invention is to provide a method and a system which makes an operation similar to the click operation and the double click operation automatically occur for a user with tenosynovitis who wants to reduce as much as possible the number of times of the click operation and a physically handicapped person who has difficulty with the click operation itself.

Yet another object of the present invention is to provide a method and a system which can prevent the occurrence of the click operation when working inputting letters.

In order to accomplish the above-mentioned objects, in a click operation automation technique according to the present invention a movement status of the cursor and an input status from the keyboard are monitored and when it is confirmed that the movement of the cursor is stopping for a predetermined time and also the letter input from the keyboard has not been performed within a predetermined time, a click event is made to automatically occur.

Also, according to the present invention the user can arbitrarily set a stopping time of the cursor and a standby time after a keyboard input.

Moreover, according to the present invention the user can switch easily the single click, the double click, and the right click, etc. depending on the usage.

Further, according to the present invention the user can conduct a drag operation without pressing down the mouse button by the detection of the pressing down of a drag starting and ending keys designated by the user.

With such a configuration the user can lighten the strain on the hand and fingers and labor by the click operation because he or she can reduce greatly the number of times of the click operation in the computer operation. Also, when working inputting letters from the keyboard if the hands or arms touch the mouse involuntarily and the cursor on the screen moves, the focus can move to an unintentional position or window, but by monitoring the input status from the keyboard and nullifying the click operation if a predetermined time has not passed from the last keyboard input occurrence, the unintentional movement of the focus at such letter inputting work can be avoided.

Also, by being able to change easily the type of the click to single or double, the user can perform a variety of operations without pressing the button. For example, by automating the single click the Web browsing or the mail operation is possible. Moreover, by automating the double click the operation such as opening a folder or a file becomes possible. Further, by automating the right click the operation of opening a menu screen becomes possible and if the cursor stops on a menu to be selected for a predetermined time the click event occurs again and the user can select the menu.

Also, by reproducing a sound when the click operation occurs the occurrence of the click can be presented to the user. It is preferable that the user can set freely about whether the sound is to be reproduced or not.

Other objects, features and advantages of the invention will become apparent from the following description of the embodiments of the invention taken in conjunction with the accompanying drawings.

### BRIEF DESCRIPTION OF THE DRAWINGS

FIG. 1 is an explanatory diagram showing a total schematic view of an input system according to the present invention.

FIG. 2 is an explanatory diagram showing a condition setting screen of the input system according to the present invention.

FIG. 3 is an explanatory diagram showing a flow of a process which monitors the movement of the cursor and the input from the keyboard and until makes a click operation occur of the input system according to the present invention.

FIGS. 4A-4C are explanatory diagrams showing an unintentional movement of a mouse focus which occurs when an input from the keyboard is not considered in the input system according to the present invention.

FIGS. 5A-5C are explanatory diagrams showing an example which avoids the unintentional movement of the mouse focus considering the input from the keyboard in the input system according to the present invention.

FIGS. 6A-6B are explanatory diagrams showing an effect of a function which makes a single click automatically occur on a Web browser in the input system according to the present invention.

FIGS. 7A-7D are explanatory diagrams showing an effect of a function which makes a single click, a double click, and a right click automatically occur in a window operation scene of the input system according to the present invention.

FIGS. 8A-8C are explanatory diagrams showing a method which presents a click type in the input system according to the present invention.

FIG. 9 is an explanatory diagram showing a flow of a process which monitors the input from the keyboard until makes a drag operation occur in the input system according to the present invention.

### DESCRIPTION OF THE EMBODIMENTS

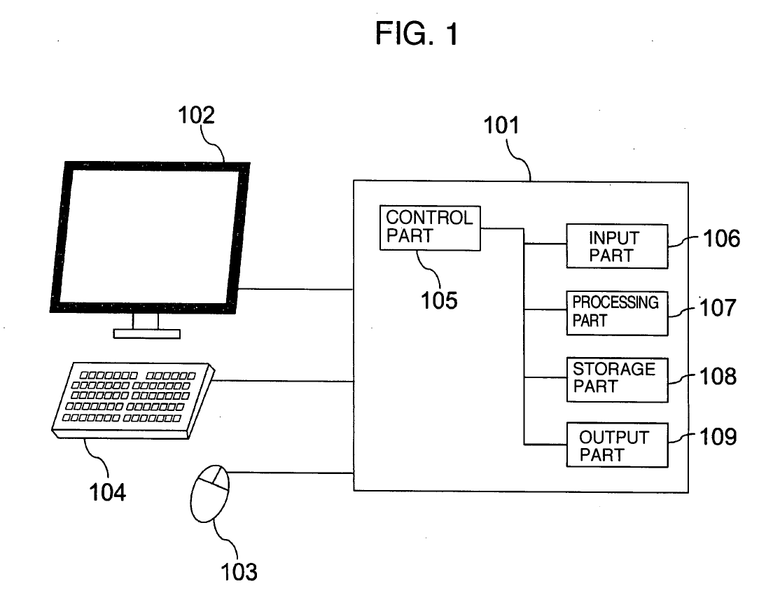

An embodiment according to the present invention will be explained in detail below referring to from FIG. 1 to FIG. 9. Here, the same or similar part or arrow, etc. are indicated with the same sign and the duplicated explanation will be omitted. Further, the embodiment which will be explained below is a representative one and the present invention is not limited to this embodiment.

FIG. 1 is a total configuration diagram of the embodiment of the input system according to the present invention, in which 101 denotes a computer system, 102 denotes a monitor, 103 denotes a mouse, 104 denotes a keyboard, and the monitor 102, the mouse 103, and the keyboard 104 are input/output interfaces when operating the computer system 101. The automatic click input system according to the present invention is a program which runs on the computer system 101 configured including an input part 106 which obtains a cursor position and a keyboard input, a processing part 107 which monitors a cursor movement and a letter input status, a storage part 108 which stores a predetermined time that has been predetermined by the user, etc., an output part 109 which makes a click event occur, and a control part 105 which controls the input part 106, the processing part 107, the storage part 108, and the output part 109.

In the same figure, the mouse 103 can be substituted by another input device which can be used to designate the cursor position such as, for example, a joystick and a touch pad, and it is not limited to the mouse.

Also in the same figure, the automatic click input system can be provided as a program incorporable to the computer system or it is possible that the program is provided as a program which is to be stored in an external storage device connected to the computer system or in a storage medium. In this embodiment it is explained assuming the former case.

Also in the same figure, the automatic click input system can be provided as a program which is automatically activated when the computer system 101 is activated.

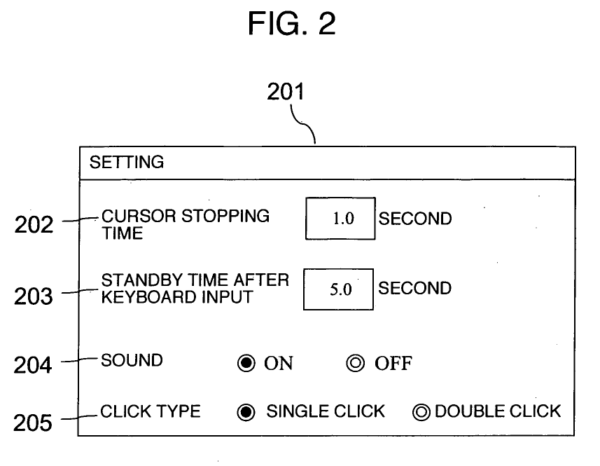

FIG. 2 shows an example of the setting screen for the automatic click input system of the present invention. When a setting screen 201 is opened and a cursor stopping time until a click event occurrence 202, a standby time after a keyboard input 203, whether a sound is reproduced or not when a click event occurs 204, and a kind of click (single click or double click, etc.) 205 are set, the setting values are stored respectively and they are reflected when the same program is activated next time.

In the same figure, to the time until a click event occurrence 202 the time from when the cursor stops until when the click event occurs is set.

Also in the same figure, to the standby time after a keyboard input 203 the standby time during which the occurrence of the click event is nullified if there has been an input from the keyboard although the cursor is stopping is set.

Also in the same figure, to whether the sound is reproduced or not whether a sound effect to present that the click operation has been conducted is used or not when the click event occurs is set.

Also in the same figure, the selection of the click type is to select the type of the click such that whether the event which is to occur is a single click or a double click. About the selection of the click type it is possible to perform it on the setting screen or the kind of the click may be switched detecting whether a certain key on the keyboard has been pressed or not. Also it is possible to add a right click or a drag function, etc. other than those.

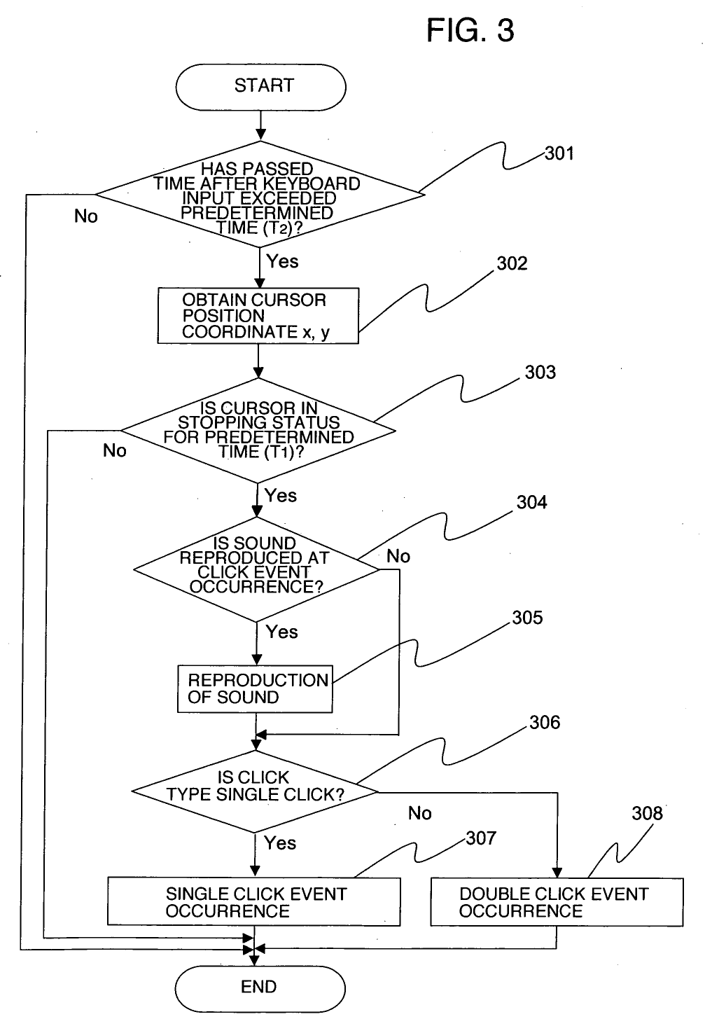

FIG. 3 shows a flow of a process which monitors the cursor position and the keyboard input status until makes a click event occur. At step 301, referring to the standby time after a keyboard input T₂ (seconds) set in the condition setting screen as shown in FIG. 2, it is decided whether the T₂ (seconds) has passed from the time when there was the last keyboard input. If the T₂ (seconds) has passed from the last keyboard input time, the process proceeds to step 302 (Yes), if there has been a keyboard input within the T₂ (seconds) retroactively from the present time, the process is terminated (No). At step 302 a present cursor position coordinate (x, y) is obtained. At step 303 referring to the cursor stopping time until a click operation occurrence T₁ (seconds) set in the condition setting screen shown in FIG. 2, it is decided whether the cursor position coordinate (x, y) is stopping for the T₁ (seconds) or not. If it is stopping for the T₁ (seconds) the process proceeds to step 304 (Yes), if there has seen a movement of the cursor during the T₁ (seconds) retroactively from the present time, the process is terminated (No). At step 304 referring to whether the sound is reproduced or not set in the condition setting screen shown in FIG. 2, if the sound is to be reproduced the process proceeds to step 305 (Yes) and the effect sound of when the click occurs is reproduced, and if it is not to be reproduced the process proceeds to step 306 (No). At step 306 the click type (whether it is a single click or a double click) set by the user is decided and if it is a single click the process proceeds to step 307 (Yes) and a single click event is made to occur, if it is a double click the process proceeds to step 308 (No) and a double click event is made to occur.

In the same figure the click type is not limited to the single click and the double click, a right click or a drag operation, etc. is possible. In the same figure it is explained using two kinds of click types of the single click and the double click as an example.

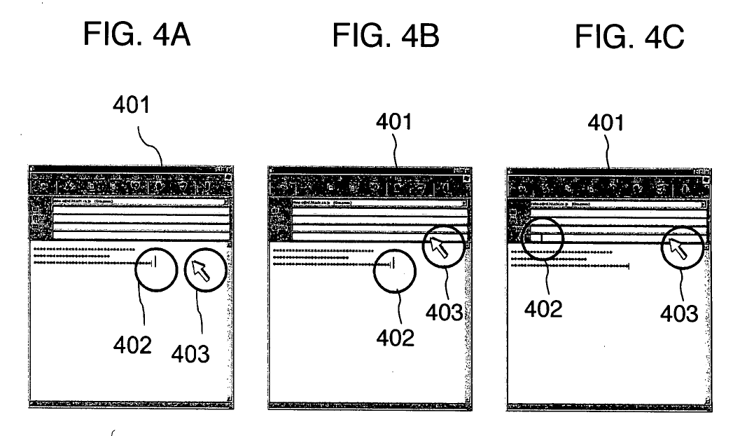

FIGS. 4A-4C shows the problem which occurs when a click operation has occurred unintentionally when working at keyboard input in the automatic click operation input system of the present invention. 401 denotes a window seen in a typical mail software, 402 denotes a caret which is a letter input pointer, and 403 denotes a cursor. When the caret and the cursor are closely situated as shown in FIG. 4A sometimes the existence of the cursor can be felt nuisance and the user wants to move it to a place a little distant from the caret, but if the method which performs the click occurrence decision only with the stopping time of the cursor as a condition is adapted, when, for example, the cursor is moved to the text input enabled area other than the place presently the user is inputting and is stopped as shown in FIG. 4B, the caret can be moved to the form of the moving destination after the predetermined time as shown in FIG. 4C. Presently, the problem by the movement as described above does not occur as long as the caret moves within the text input enabled area which is displayed, but if the user has to be careful with the moving destination of the cursor so that such a problem doe not occur, he or she can not be concentrated in the text inputting work.

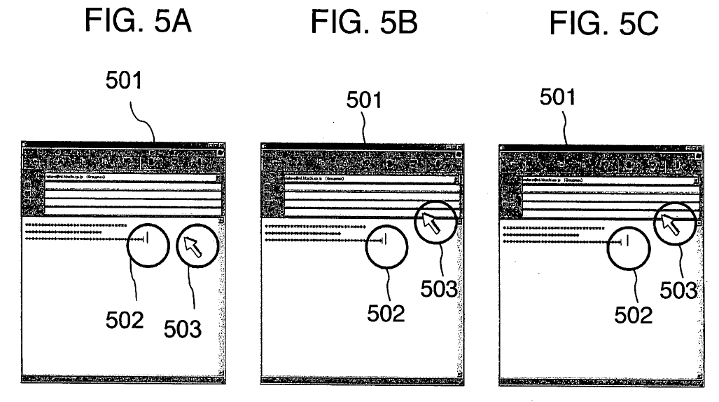

FIGS. 5A-5C shows an example which avoids the problem which occurs when a click operation has occurred unintentionally when working at keyboard input in the automatic click operation input system of the present invention. 501 denotes a window seen in a typical mail software, 502 denotes a caret which is a letter input pointer, 503 denotes a cursor. When the caret and the cursor are closely situated as shown in FIG. 5A sometimes the existence of the cursor can be felt nuisance and the user wants to move it to a place a little distant from the caret, when, for example, the cursor is moved to the text input enabled area other than the place presently the user is inputting and is stopped as shown in FIG. 5B, the movement of the caret with the cursor can be avoided as shown in FIG. 5C by monitoring the input status from the keyboard and by not performing the automatic click operation by the cursor stopping within the standby time after a keyboard input determined by the user.

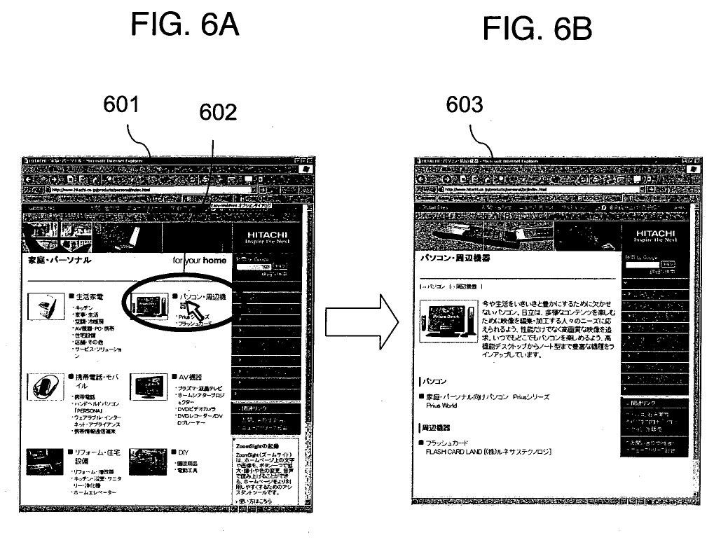

FIGS. 6A, 6B show the effect when working using a Web browser of the automatic click operation input system of the present invention. 601 denotes an example of a Web page and 602 denotes a cursor. On a typical Web browser the user can conduct the operations such as opening a page of the linked destination or returning to the original page only with the click operation of the mouse. In this case, using the automatic click input system of the present invention, the user can open the page of the linked destination 603 as shown in FIG. 6B only by moving the cursor 602 on to a display showing the linked destination on the Web page 601 and stopping it as shown in FIG. 6A. With similar operation the user can conduct almost all operations such as returning to the original page, updating the page, closing the Web browser itself, etc. without clicking by himself or herself but only by moving the mouse and stopping it.

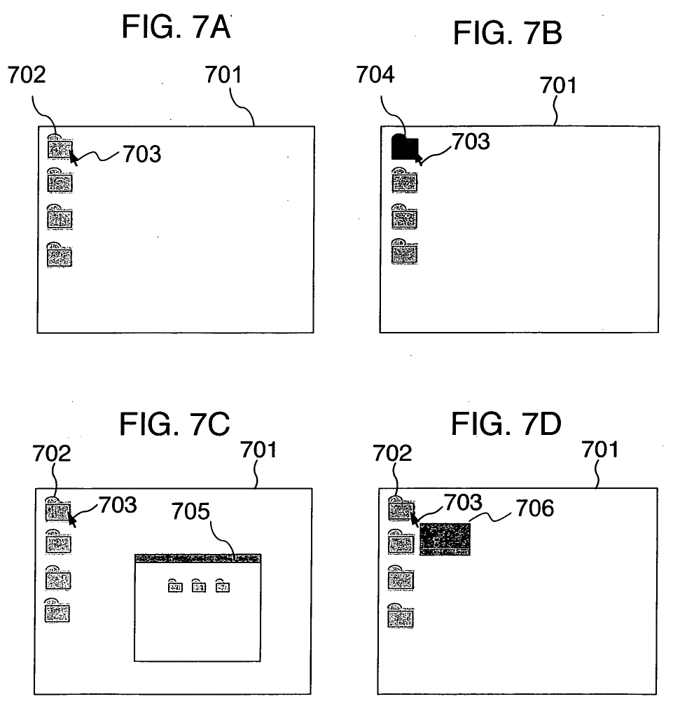

FIGS. 7A-7D show the effect obtained by the kinds of the click of the automatic click operation input system of the present invention. FIG. 7A shows a case where the input system is not used, FIG. 7B shows a case where the single click is used in the input system, FIG. 7C shows a case where the double click is used in the input system, and FIG. 7D shows a case where the right click is used in the input system. 701 denotes a typical screen when the user operates a computer, 702 denotes a folder icon, and 703 denotes a cursor. In the same figure it will be explained in a case where a click method to select with the single click and to open with the double click is used. In the case where the input system is not used as shown in FIG. 7A, even if the cursor 703 is moved on to the folder icon 702 and stopped, there will not be seen any change in the operation. On the contrary, when the automatic single click operation is performed in the input system as shown in FIG. 7B, if the user stops the cursor on the folder icon 702 for a predetermined time the click operation is performed and the folder icon is selected and as a result it is displayed reversed as a folder icon 704. Also, when the automatic double click operation is performed in the input system as shown in FIG. 7C, if the user stops the cursor on the folder icon 702 for a predetermined time an opening operation is performed for the folder icon 702 and its contents are displayed as a folder window 705. Also, when the automatic right click operation is performed in the input system as shown in FIG. 7D, if the user stops the cursor on the folder icon 702 for a predetermined time, a right menu 706 is opened.

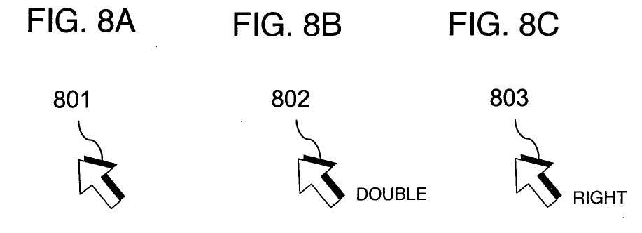

FIGS. 8A-8C show a presentation method when the user switches the kind of the click of the automatic click operation input system of the present invention. By enabling the user to switch the single click, the double click, and the right click as shown in FIGS. 7A-7D, the kinds of the operations which the user can conduct only by moving the cursor can be greatly increased. This switching between the single click, the double click, and the right click may be conducted on the condition setting screen as shown in FIG. 2, or the user may preset a certain key on the keyboard as a click type switching key and he or she may switch the click by pressing the key during the operation.

In the same figure, about which of the single click, the double click, or the right click the present setting is can be presented to the user, for example, by varying the mark of the cursor, etc. Different cursor marks can be assigned to each click type such as when the conventional cursor mark is used as shown in FIG. 8A it is a single click mode, in the case shown in FIG. 8B it is a double click mode, in the case shown in FIG. 8C it is a right click mode.

In the same figure it is preferable that the user can freely set which cursor mark is assigned to each click mode.

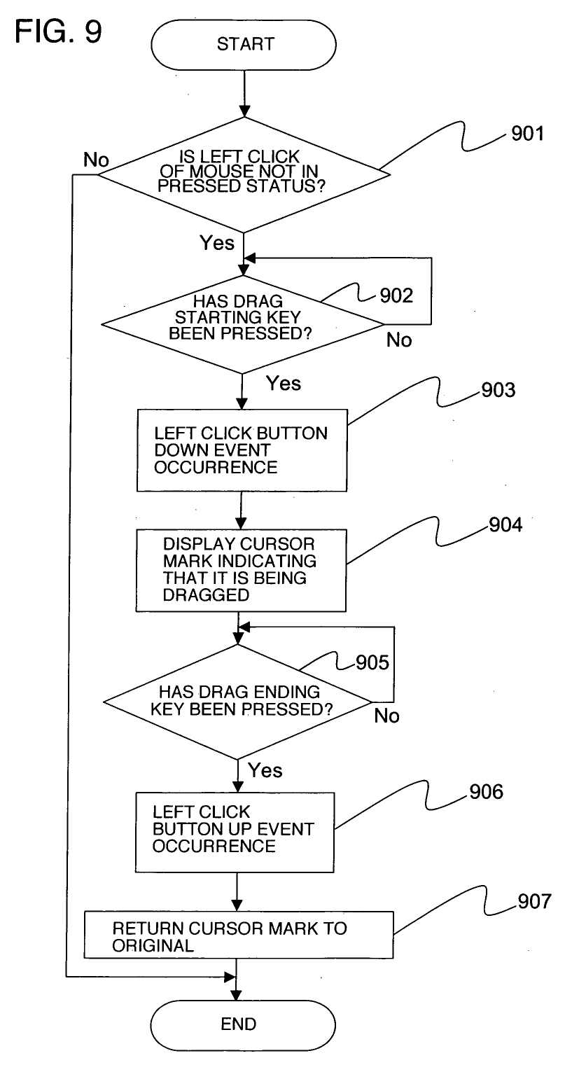

FIG. 9 shows a flow of a process until making a drag event occur of the automatic click operation input system of the present invention. The drag typically is an operation in which the user moves the cursor to the end point of an area which the user wants to select with a left click button being pressed down. In the input system it is provided a method in which a starting point and an ending point of the drag operation is detected by pressing keys which have been preset, and the drag operation is possible without that the user moves the cursor with the click button being pressed down. At step 901 a present status of the left button of the mouse is obtained and it is decided whether the left button is not in a pressed down status (not being dragged). If it is not in the pressed down status the process proceeds to step 902 (No) and if it is in the pressed down status the process is terminated (Yes). At step 902 it is decided whether the preset drag starting key has been pressed or not and if it has been pressed the process proceeds to step 903 (Yes) and if it has not been pressed the process waits (No). At step 903 a left button down event occurs and the process proceeds to step 904. At step 904 the process displays a cursor mark indicating that it is being dragged and the process proceeds to step 905. At step 905 it is decided whether the preset drag ending key has been pressed or not and if it has been pressed the process proceeds to step 906 (Yes) and it if has not been pressed the process waits (No). At step 906 a left button up event occurs and the process proceeds to step 907. At step 907 the process displays an original cursor mark and the process is terminated. Thereby the drag operation which is conventionally needed to be operated with the left click button being pressed down can be substituted by only pressing the keys on the keyboard without pressing the button, thereby the strain put on the user's hand and fingers can be greatly lightened.

In the same figure, the keys indicating the starting point and the ending point of the drag operation may be set on the condition setting screen such as shown in FIG. 2.

Also in the same figure, the keys indicating the starting point and the ending point of the drag operation may use the keys on the keyboard, each of them may be different key respectively or they may be the same key.

It should be further understood by those skilled in the art that although the foregoing description has been made on embodiments of the invention, the invention is not limited thereto and various changes and modifications may be made without departing from the spirit of the invention and the scope of the appended claims.

1. A click input operation occurrence method which makes a click input operation occur in a computer to which a coordinate input device and a keyboard are connected, comprising:
a first step of detecting whether there has been an input from the keyboard or not;
a second step of detecting whether there has been a change in a coordinate input from the coordinate input device or not; and
a third step of executing a command associated with the click input from the coordinate input device when a time in which an input from the keyboard has not been detected is equal to or over a first predetermined time and a time in which there has not been a change in the coordinate is equal to or over a second predetermined time.

2. A click input operation occurrence method according to claim 1, further comprising:
a fourth step of having as alternatives at least two of a single click, a double click, a left click, and a right click, and setting any of them as the click input in the third step.

3. A click input operation occurrence method according to claim 1, further comprising:
a fifth step of accepting a setting input in which a user sets at least one of the first predetermined time and the second predetermined time.

4. A click input operation occurrence method according to claim 1, wherein:
in the third step a sound occurrence indicating the click input operation occurrence is performed in accordance with the execution of the command.

5. A click input operation occurrence program which makes a click input operation occur in a computer to which a coordinate input device and a keyboard are connected, comprising:
a first step of detecting whether there has been an input from the keyboard or not;
a second step of detecting whether there has been a change in a coordinate input from the coordinate input device or not; and
a third step of executing a command associated with the click input from the coordinate input device when a time in which an input from the keyboard has not been detected is equal to or over a first predetermined time and a time in which there has not been a change in the coordinate is equal to or over a second predetermined time.

6. A click input operation occurrence program according to claim 5, further comprising:
a fourth step of having as alternatives at least two of a single click, a double click, a left click, and a right click, and setting any of them as the click input in the third step.

7. A click input operation occurrence program according to claim 5, further comprising:
a fifth step of accepting a setting input in which a user sets at least one of the first predetermined time and the second predetermined time.

8. A click input operation occurrence program according to claim 5, wherein:
in the third step a sound occurrence indicating the click input operation occurrence is performed in accordance with the execution of the command.

9. A computer system including a coordinate input device, a keyboard, and a process computing part, comprising:
the keyboard which accepts a key input by a user;
the coordinate input device which accepts a coordinate input by the user; and
the process computing part which executes a command associated with a click input from the coordinate input device when a time in which an input from the keyboard has not been detected is equal to or over a first predetermined time and a time in which there has not been a change in the coordinate is equal to or over a second predetermined time.

10. A computer system according to claim 9, wherein:
the process computing part has as alternatives at least two of a single click, a double click, a left click, and a right click, and accepts a user setting input to set any of them as the click input to decide the input using the first and the second predetermined time.

11. A computer system according to claim 9, wherein:
the process computing part accepts a user setting input to set at least one of the first predetermined time and the second predetermined time.

12. A computer system according to claim 9, further comprising:
a sound occurrence device which performs a sound occurrence which indicates the click input operation occurrence in accordance with the execution of the command.

13. A drag operation input occurrence program which makes a drag operation input occur in a computer to which a coordinate input device and a keyboard are connected, comprising:
a first step of detecting whether there has been a first or a second key input from the keyboard or not;
a second step of detecting a coordinate input from the coordinate input device; and
a third step of executing a command associated with the drag operation input from the coordinate input device with the detected coordinate when the first key input is detected as a drag starting position and with the detected coordinate when the second key input is detected as a drag ending position.
